(19) United States
(12) Patent Application Publication
(10) Pub. No.: US 2007/0060299 A1
(43) Pub. Date: Mar. 15, 2007

(54) Open-Ended Bonus Game And Method

(75) Inventors: Loren T. Nelson, Las Vegas, NV (US); Jesse Ruppert, Las Vegas, NV (US)

Correspondence Address: BALLY GAMING INC., 6601 S. BERMUDA ROAD, LAS VEGAS, NV, 89119, US

(73) Assignee: BALLY GAMING, INC., Las Vegas, NV (US)

(21) Appl. No.: 11/530,823

(22) Filed: Sep. 11, 2006

Related U.S. Application Data
(60) Provisional application No. 60/715,763, filed on Sep. 10, 2005.

(51) Int. Cl. A63F 13/00

(52) U.S. Cl. 463/20

(57) ABSTRACT

An open-ended bonus game and method are disclosed. A game contains a bonus game initiated upon a triggering event and a register that is modified by one or more units based on predefined criteria. The bonus game terminates when the register contains a predefined value.

### RELATED APPLICATIONS

This application claims priority from provisional application 60/715,763 filed on Sep. 10, 2005, hereby incorporated by reference.

### FIELD OF THE INVENTION

The present invention is directed to gaming games and methods and, more particularly, to games and methods that provide an open-end bonus.

### BACKGROUND OF THE INVENTION

In the prior art, various types of gaming machines have been developed with different features to captivate and maintain player interest. For example, gaming machines may include flashing displays, lighted displays, or sound effects to capture a player's interest in a gaming device. In general, a gaming machine allows a player to play a game in exchange for a wager. Depending on the outcome of the game, the player may be entitled to an award which is paid to the player by the gaming machine, normally in the form of currency or game credits.

Another important feature of maintaining player interest in a gaming machine includes providing the player with many opportunities to win awards, such as cash or prizes. For example, in some slot machines, the display windows show more than one adjacent symbol on each reel, thereby allowing for multiple-line betting. Other types of slot machines have been developed that offer second-chance or bonus games that provide players with additional opportunities to win, such as with additional free spins. Some gaming machines offer a player the opportunity to win millions of dollars by providing progressive jackpots; while some gaming machines include bonus games that are used to entice and enhance player excitement. For instance, bonus features of various types have been employed to reward players above the amounts normally awarded on a standard game pay schedule. Generally, such bonus features are triggered by predetermined events such as one or more appearances of certain combinations of indicia in the “base game”. In order to stimulate interest, bonus awards are typically set to occur at a gaming machine on a statistical cycle based upon the number of base game plays.

While gaming machines including bonus games have been very successful, there remains a need for games that provide a player with enhanced excitement and increased opportunity of winning.

### SUMMARY OF THE INVENTION

In accordance with one aspect of the present invention, a game includes an interface activatable by a player and at least one of a set of possible outcomes determined after activation of the interface by the player, the set of possible outcomes including a winning subset of outcomes. The game further includes a bonus game initiated upon a triggering event and a register that is modified by one or more units based on predefined criteria. The bonus game terminates when the register contains a predefined value.

In accordance with one embodiment of the invention, a method of operating a game includes the step of selecting one of a set of possible outcomes of the game, the set of possible outcomes including a winning subset of outcomes. The method further includes the steps of, upon a triggering event, initiating a bonus game, modifying a register by one or more units based on predefined criteria and terminating the bonus game when the register contains a predefined value.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a perspective view of a gaming machine in accordance with one aspect of the present invention.

FIG. 2 is a block diagram of the physical and logical components of the gaming machine of FIG. 1.

FIG. 3 is a display image associated with a game of one embodiment of the invention.

FIG. 4 is a display image of a multi-page pay table for a game in accordance with one aspect of the invention.

FIGS. 5-9 are display images of a game awarding bonus games in accordance with one embodiment of the invention.

FIG. 10 is a functional block diagram depicting the steps associated with carrying out a method in accordance of one aspect of the invention.

FIG. 11 is a schematic block diagram showing the hardware elements of a networked gaming system in accordance with one aspect of the present invention.

### DETAILED DESCRIPTION OF THE INVENTION

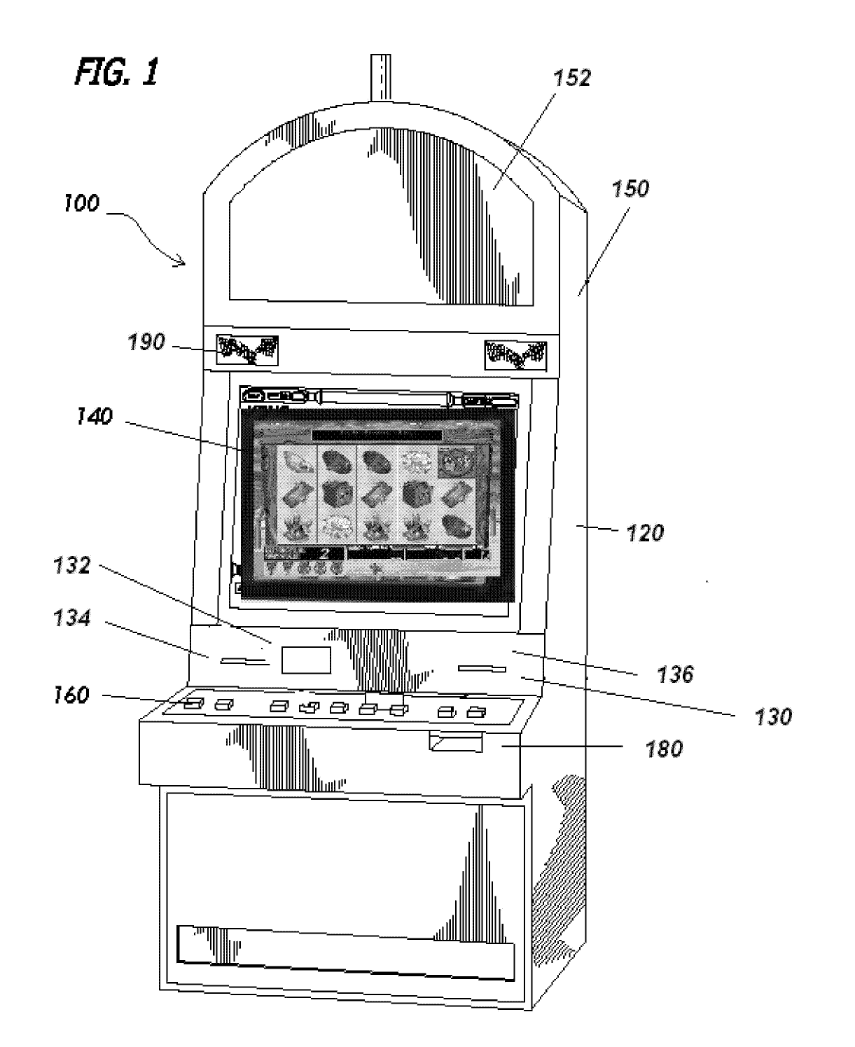

In accordance with one aspect of the present invention, FIG. 1 illustrates a gaming machine 100 including cabinet housing 120, base game display 140, player-activated buttons 160, player tracking panel 136, bill/voucher acceptor 180 and one or more speakers 190. Cabinet housing 120 is a self-standing unit that is generally rectangular in shape and may be manufactured with reinforced steel or other rigid materials which are resistant to tampering and vandalism. Cabinet housing 120 houses a processor, circuitry, and software (not shown) for receiving signals from the player-activated buttons 160, operating the games, and transmitting signals to the respective displays and speakers. Any shaped cabinet may be implemented with any embodiment of gaming machine 100 so long as it provides access to a player for playing a game. For example, cabinet 120 may comprise a slant-top, bar-top, or table-top style cabinet. The operation of gaming machine 100 is described more fully below.

The plurality of player-activated buttons 160 may be used for various functions such as, but not limited to, selecting a wager denomination, selecting a game to be played, selecting a wager amount per game, initiating a game, or cashing out money from gaming machine 100. Buttons 160 function as input mechanisms and may include mechanical buttons, electromechanical buttons or touch screen buttons. Optionally, a handle (not shown) may be rotated by a player to initiate a game.

In other embodiments, buttons 160 may be replaced with various other input mechanisms known in the art such as, but not limited to, a touch screen system, touch pad, track ball, mouse, switches, toggle switches, or other input means used to accept player input. For example, one input means is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of pay lines to play in a game and the number of credits to bet per line.

Cabinet housing 120 may optionally include top box 150 which contains “top glass” 152 comprising advertising or payout information related to the game or games available on gaming machine 100. Player tracking panel 136 includes player tracking card reader 134 and player tracking display 132. Voucher printer 130 may be integrated into player tracking panel 136 or installed elsewhere in cabinet housing 120 or top box 150.

Game display 140 presents a game of chance wherein a player receives one or more outcomes from a set of potential outcomes. For example, one game of chance is a video slot machine game, an example of which is entitled Rock Hound. The Rock Hound game features a basic slot machine game with five simulated spinning reels and is further described below. In other aspects of the invention, gaming machine 100 may present a mechanical reel slot machine, a video poker game, a video keno game, a lottery game, a bingo game, a Class II bingo game, a roulette game, a craps game, a blackjack game, a mechanical or video representation of a wheel game or the like. In alternative embodiments, it may further be appreciated that games of skill or games of chance involving some player skill may be implemented with gaming machine 100.

Mechanical or video/mechanical embodiments may include game displays such as mechanical reels, wheels, or dice as required to present the game to the player. In video/mechanical or pure video embodiments, game display 140 is, typically, a CRT or a flat-panel display in the form of, but not limited to, liquid crystal, plasma, electroluminescent, vacuum fluorescent, field emission, or any other type of panel display known or developed in the art. Game display 140 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 140 preferably includes a touch screen or touch glass system (not shown) and presents player interfaces such as, but not limited to, credit meter 144, win meter 142 and touch screen buttons 146. An example of a touch glass system is disclosed in U.S. Pat. No. 6,942,571, entitled “Gaming Device with Direction and Speed Control of Mechanical Reels Using Touch Screen,” which is hereby incorporated by reference.

Game display 140 may also present information such as, but not limited to, player information, advertisements and casino promotions, graphic displays, news and sports updates, or even offer an alternate game. This information may be generated through a host computer networked with gaming machine 100 on its own initiative or it may be obtained by request of the player using either one or more of the plurality of player-activated buttons 160; the game display itself, if game display 140 comprises a touch screen or similar technology; buttons mounted about game display 140 (not shown) which may permit selections such as those found on an ATM machine, where legends on the screen are associated with respective selecting buttons; or any player input device that offers the required functionality.

Cabinet housing 120 incorporates a single game display 140. However, in alternate embodiments, cabinet housing 120 or top box 150 may house one or more additional displays or components (not shown) used for various purposes including additional game play screens, animated “top glass,” progressive meters or mechanical or electromechanical devices such as, but not limited to, wheels, pointers or reels. The additional displays may or may not include a touch screen or touch glass system.

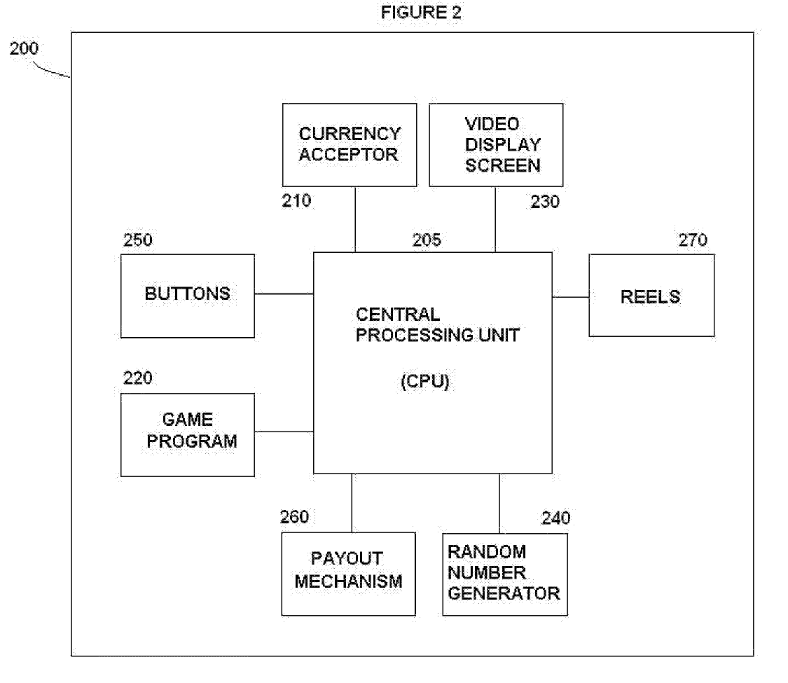

In accordance with one embodiment of the present invention, FIG. 2 is a block diagram showing the interconnection of physical and logical components 200 of gaming machine 100. Currency acceptor 210 is typically connected to central processing unit (“CPU”) 205 by a serial connection such as RS-232 or USB. CPU 205 executes game program 220 that causes video display screen 230 to display a game that includes a plurality of simulated indicia-bearing reels 270. In one embodiment, game program 220 is a game such as Rock Hound, described further below.

When a player has inserted a form of currency such as, for example and without limitation, paper currency, coins or tokens, cashless tickets or vouchers, electronic funds transfers or the like into currency acceptor 210, a signal is sent to CPU 205 which, in turn, assigns an appropriate number of credits for play. The player may further control the operation of gaming machine 100, for example, to select the number of pay lines to play and the amount to wager via electromechanical or touchscreen buttons 250. The game starts in response to the player pulling a lever or pushing one of buttons 250, the detection of which causes CPU 205 to spin reels 270 displayed on video display screen 230. Random number generator 240 responds to instructions from CPU 205 to provide a randomly selected stop position for each reel. CPU 205 then stops the reels according to the predetermined stop positions to display a plurality of reel indicia on video display screen 230. The set of possible outcomes includes a subset of outcomes related to the triggering of play of free games. In the event the displayed outcome is a member of this subset, CPU 205 under control of game program 220, causes reels 270 to spin one or more additional times as will be described further below.

In various embodiments of gaming machine 100, game program 220 is stored in a memory device (not shown). By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with gaming machine 100 are stored in the same or a separate memory device (not shown).

Predetermined payout amounts for certain combinations of reel indicia, including bonus game outcomes, are stored as part of game program 220. Such payout amounts are, in response to instructions from CPU 205, provided to the player in the form of coins, credits or currency via payout mechanism 260, which may be one or more of a credit meter, a coin hopper, a voucher printer, an electronic funds transfer protocol or any other payout means known or developed in the art.

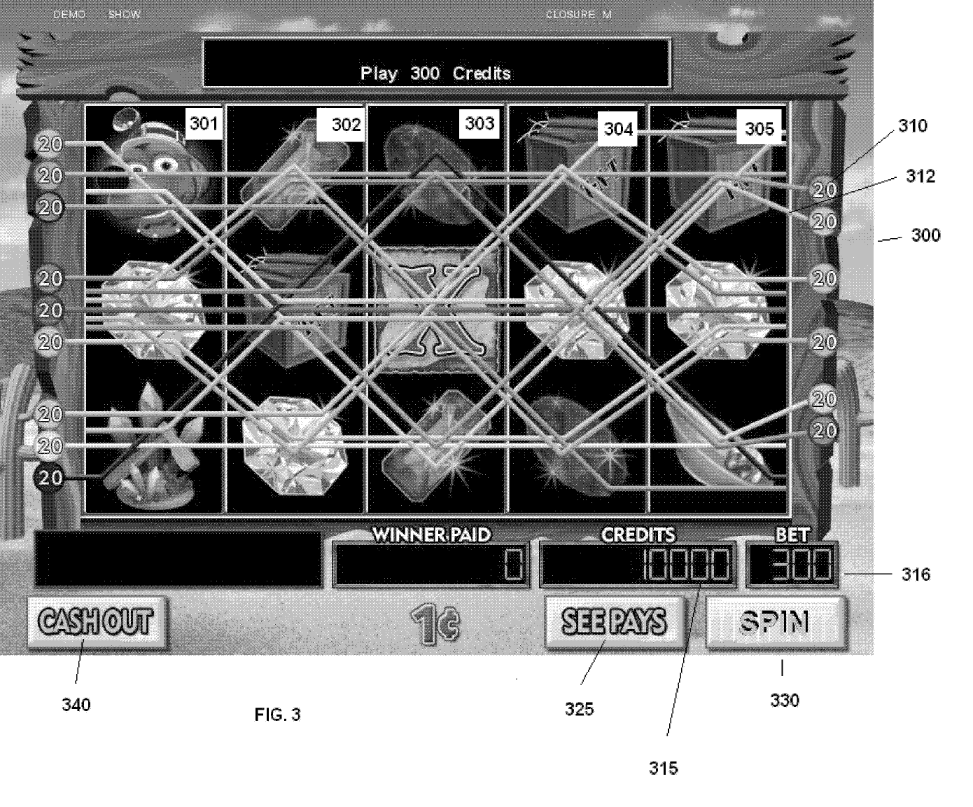

Turning now to FIG. 3, in accordance with one embodiment of the invention, the Rock Hound game is implemented on video display 300 using five simulated spinning reels 301-305. Each of 15 pay line patterns 312 (shown superimposed on the normal game screen) passes through one indicium on each of the five reels 301-305. The number of pay lines and their patterns are by way of example only and may vary. The player selects the number of played pay lines and the number of credits or coins wagered on each line using touch screen controls (not shown) or buttons 160 (FIG. 1). The player may also collect the balance of his credits by pressing CASH OUT button 340.

Credit meter 315 display the player's current credit balance, while other meters 316 may display, for example, the number of credits or coins wagered and the last amount paid by the payout mechanism 260 (FIG. 2). Other meters 316 containing other information may be displayed. The amount wagered on each pay line is additionally indicated by a bet tag 310 corresponding to each pay line. In the example shown, 20 credits have been wagered on each of the 15 pay lines.

The player initiates game play by pressing SPIN button 330. In some embodiments, the player may simultaneously select all pay lines at the maximum number of coins or credits allowed per line by pressing a MAX BET touch screen button (not shown). Corresponding buttons 160 (FIG. 1) may be used instead of the touch screen buttons to perform the actions described here without deviating from the scope of the invention. A video representation of reels 301-305 is made to spin and stop in their predetermined stop positions and then indicate whether the stop positions of the reels resulted in a winning game outcome.

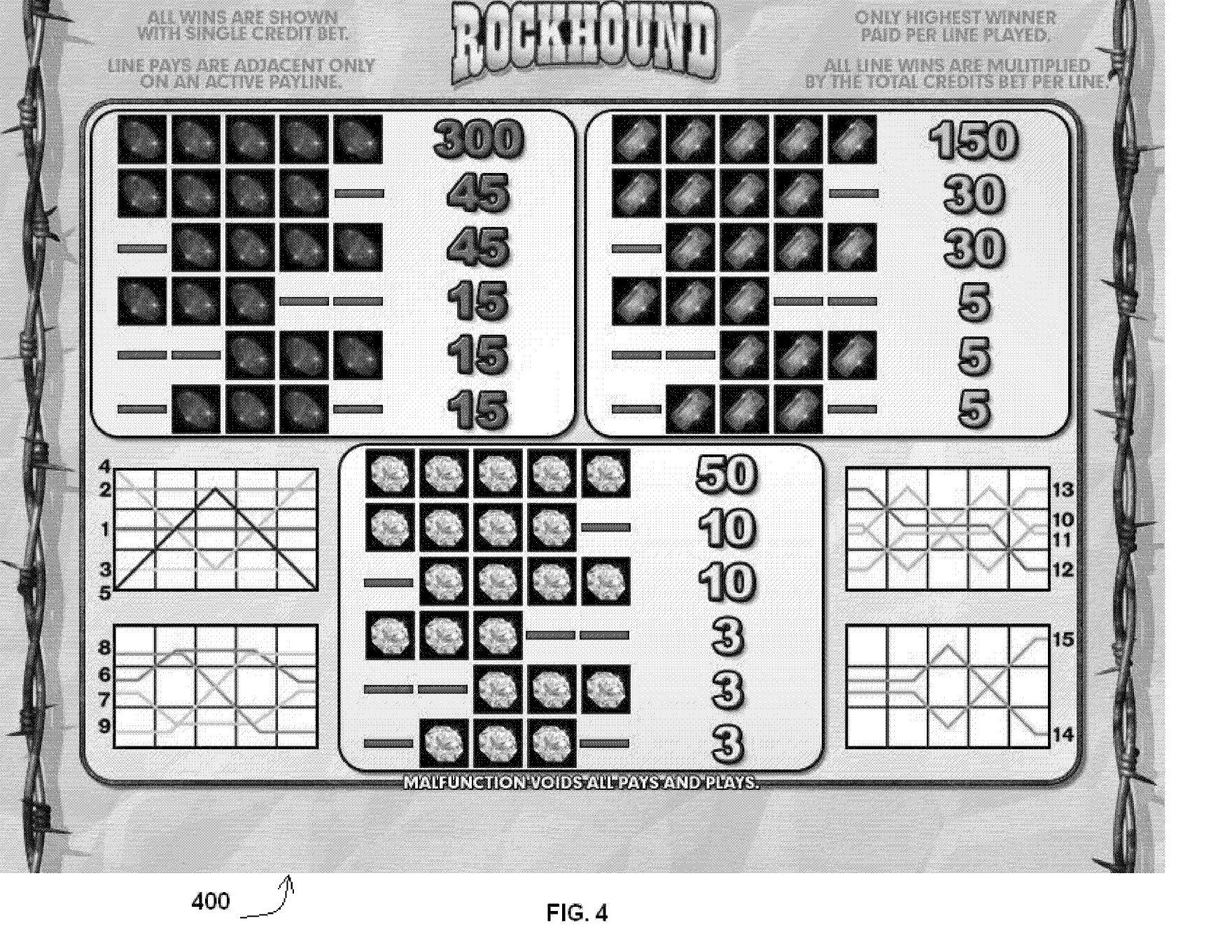

Winning outcomes may be indicated on a pay table. An example of part of a pay table 400 is shown in FIG. 4. The pay table may be accessible through a SEE PAYS “help” button 325. In alternate embodiments, the pay table may be presented on a second video or printed display attached to the gaming machine (i.e. a “pay glass”, FIG. 1, 152). A winning combination, for example, could be three or more green gem symbols adjacent to one another on an active pay line. For each winning combination, the game device awards the player the award in the pay table, adjusted as necessary based on the number of credits wagered on the pay line on which the win occurred. Some representations of pay tables may factor in the amount of the player's wager and no additional award adjustment is required.

In various embodiments, winning combinations may be evaluated across adjacent reels from left-to-right, from right-to-left or both. Additional winning combinations may be awarded when certain indicia do not necessarily accumulate adjacently on a pay line, but rather, appear anywhere on the reels (i.e., “scatter pays”). In addition, “wild” indicia may be used to complete winning combinations. Some “wild” indicia may also cause completed winning combinations to be result in pay amounts in excess of the normal winning combination by way of multiplication or addition, for example, a wild doubler symbol may be used.

Once the player triggers the free game feature, a pre-determined minimum number of free games is assigned to a counter and presented to the player. A different embodiment may allow the player to choose the minimum number of free games he desires. Another embodiment may choose from a pool of pre-determined minimum number of free games to begin the bonus round. In another embodiment, the minimum number of free games is a fixed value. In the Rock Hound game, the minimum number of free games the player receives is determined by the following equation: ((total number of symbols on reel)/(number of decrementing symbols*3))*(minimum games awarded)=expected number of spins for the player.

For example, if there are 30 symbols on the fifth reel, eight decrementing symbols on reel five and five free games awarded at the minimum, the average number of free games for the player would be 6.5: (30/(8*3))*5=6.5.

It will be apparent that various base game outcomes can be utilized to trigger the play of free bonus games, including, but not limited to, awarding bonus play when certain symbols appear on a pay line, when certain symbols are scattered, when no symbols of a certain type appear, when a certain winning combination occurs or, regardless of the visible symbols, at random or fixed intervals. In other embodiments, free games that do not use reels may be awarded. For example and without limitation, free games that present cards, roll dice, spin wheels, or offer a “second screen” bonus may be awarded either on the primary game display or on a separate display or device, for example on a video display or mechanical wheel. Multipliers may or may not be applied to pays during free games. Free games may include scatter pays or be implemented on reels which are separate from the base game.

The player may press a “start” button at the beginning of each free game, or the games may proceed automatically. In the Rock Hound embodiment, the reels are spun automatically and stopped, then evaluated for any winning combinations. If winning combinations are present, the combinations are evaluated against a pay table and awarded to the player on a bonus win meter. In another embodiment, bonus wins are paid immediately following each free game.

Each time one or more predetermined “decrement” symbols appear in free game play, the number of free games remaining on the counter will be decremented once for each such symbol. If no decrementing symbols appear during a particular free game, the counter does not decrement; in effect, the player is awarded an extra free game. When the counter reaches zero, free game play is terminated and the player is awarded any accumulated win on the bonus win meter through a payout device, by transference to a credit meter or by other similar means.

The minimum number of free games awarded may be a random value. The reels used in the free games may contain the same symbols and weighted mapping as the base game reels or may contain different symbols and/or mapping as the base game reels. In the Rock Hound game, for example and not intended to be limiting in any way, the reels used in the free games have different symbols and weighting than the reels used in the base game.

In another embodiment, a free games expended counter may be initialized to zero. Each time one or more predetermined symbols appear in free game play, the free games expended counter is incremented once for each such symbol. If no incrementing symbols appear during a particular free game, the counter does not increment; in effect, the player is awarded an extra free game. When the counter reaches the number of pre-awarded free games, free game play is terminated and the player is awarded any accumulated win as described above.

The number of free games remaining or expended can be displayed in any fashion including, but not limited to, a numerical meter, a graphical meter or both. Rock Hound, for example, employs both a numerical meter and a graphical meter.

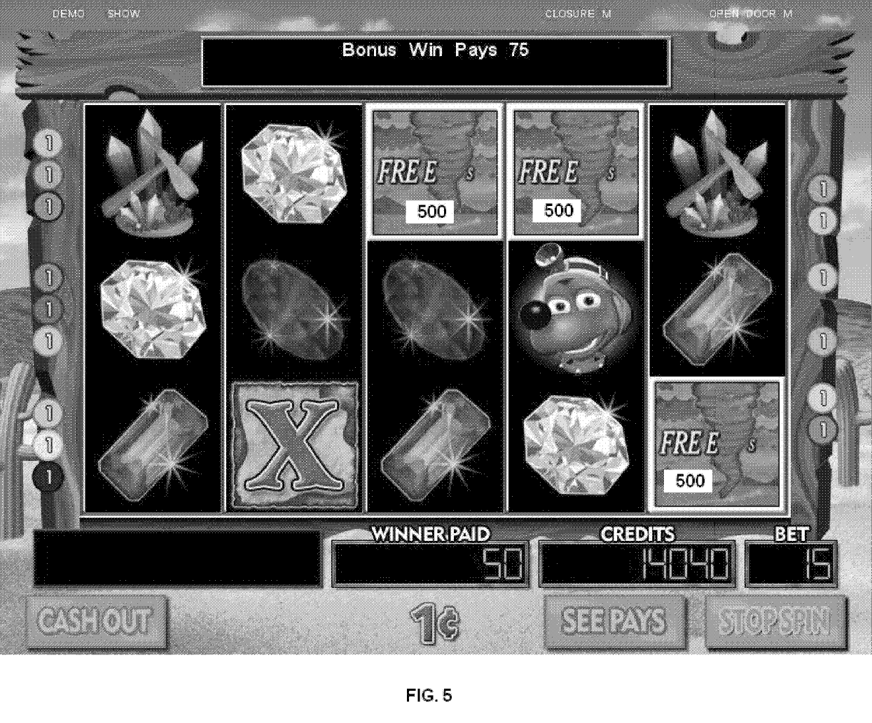

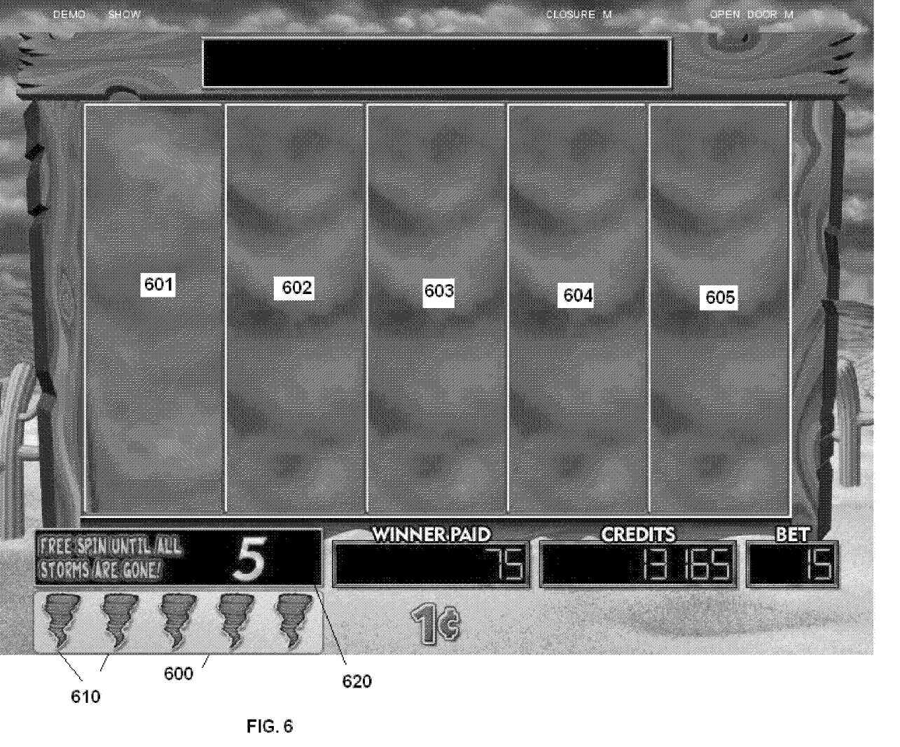

FIGS. 5-10 provide an example of free game play in accordance with one aspect of the invention. Referring to FIG. 5, three “free spin” symbols 500 appear on the reels, triggering free game play. Turning to FIG. 6, the normal reels 301-305 of FIG. 3 have been obscured, as shown on reels 601-605, in preparation for the introduction of special bonus reels. Five free games have been awarded to the player and placed in counter 600, represented both graphically, by storm icons 610, and numerically, by indicator 620.

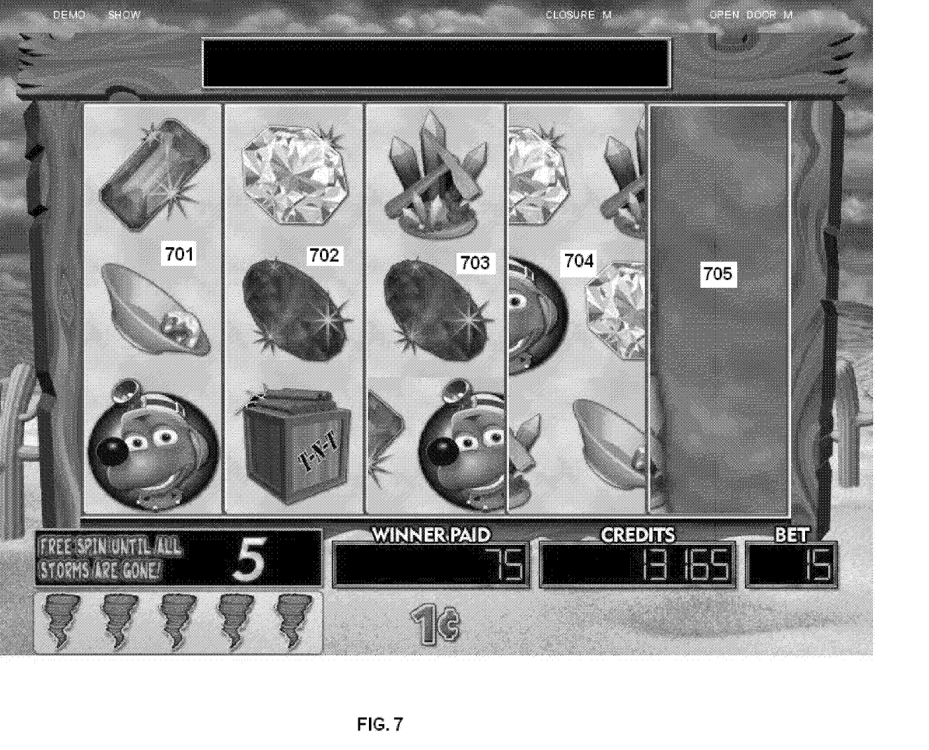

Continuing now with FIG. 7, free game play has begun as the dust from the reel-obscuring storms of FIG. 6 is replaced by spinning free game reels 701-705. Reels 701-704 are in mid-spin and reel 705 is just starting to spin. In this example, the free game reels spin horizontally. In other embodiments, the free game reels may also spin in the traditional vertical manner. In still other embodiments, the reels are spun bi-directionally. One example of bi-directional reel spins is disclosed in U.S. Pat. No. 5,251,898, entitled “Gaming Apparatus with Bi-directional Reels” which is hereby incorporated by reference.

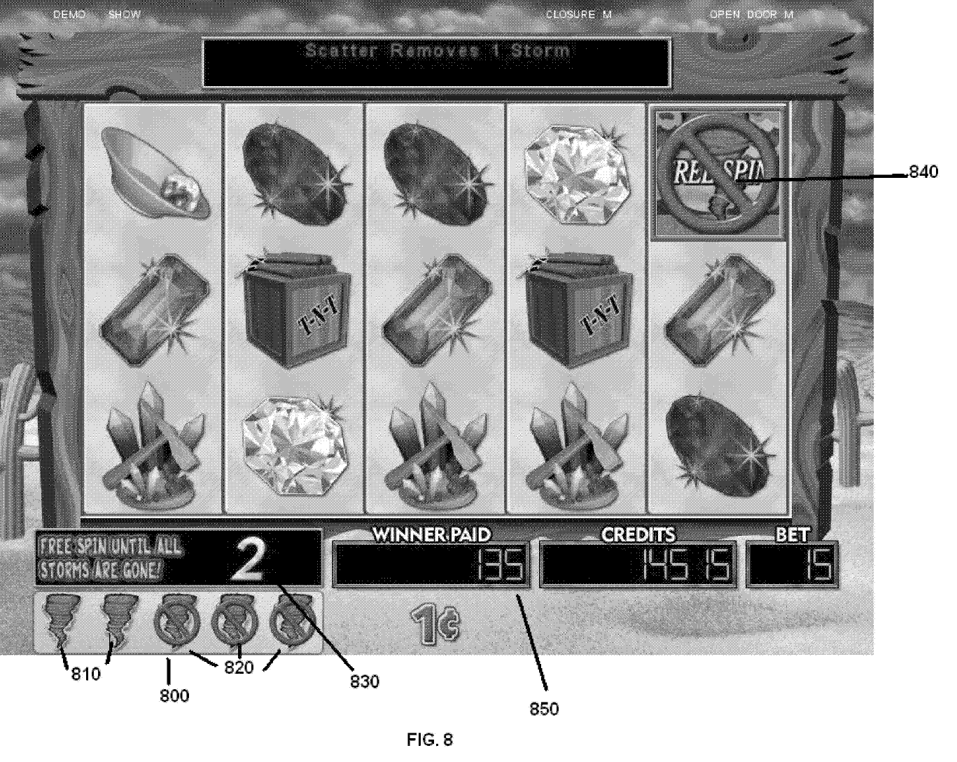

Proceeding to FIG. 8, free game play has continued into subsequent free games. The player has accumulated 135 credits in bonus wins, as shown on meter 850. Numeric indicator 830, free game icons 810 and expended free game icons 820 in free game meter 800 indicate that at least two free games remain to be played. Decrementing symbol 840 has caused one of the free game icons 810 to be replaced by an expended free game icon 820 and numeric indicator 830 to be decremented from 3 (not shown) to 2.

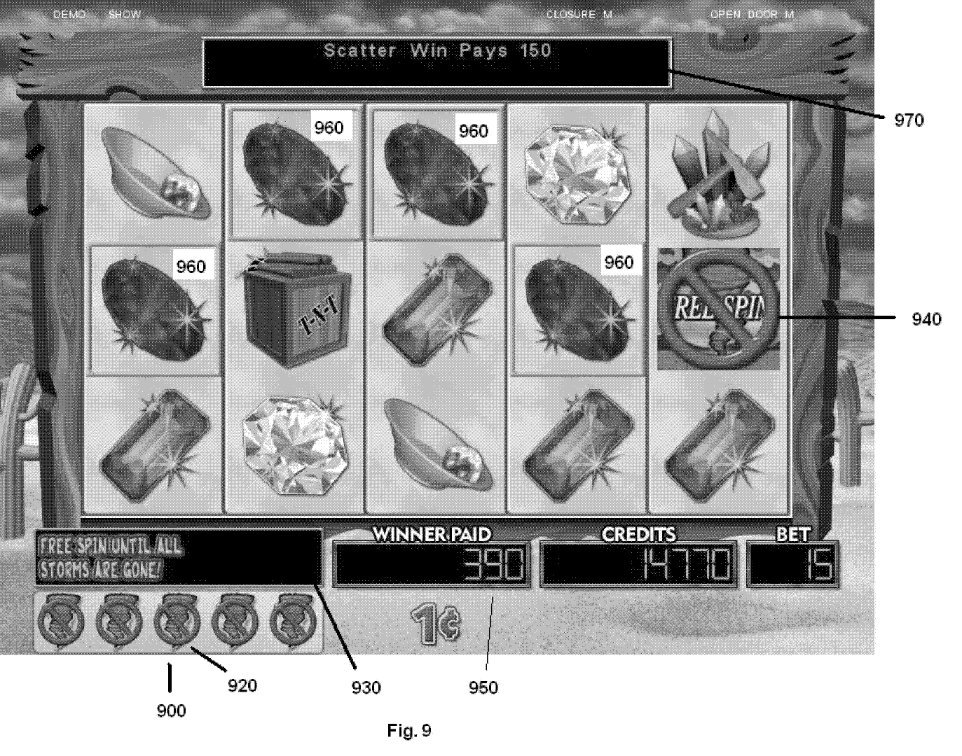

Continuing to FIG. 9, free game play has continued into subsequent free games. 4 red jewel symbols 960 have caused the player to be awarded a bonus pay of 150 credits, as shown in message 970. Decrementing symbol 940 has caused the last of the free game icons (FIG. 8, 810) to be replaced by an expended free game icon 920. The numeric indicator (FIG. 8, 830) has been removed and the expended free game icons 920 in free game meter 900 show a total of at least five free games played. The player has accumulated 390 credits in bonus wins, as shown on meter 950. The total bonus win will be transferred to the credit meter and the normal base game reels will be redrawn for resumption of normal play.

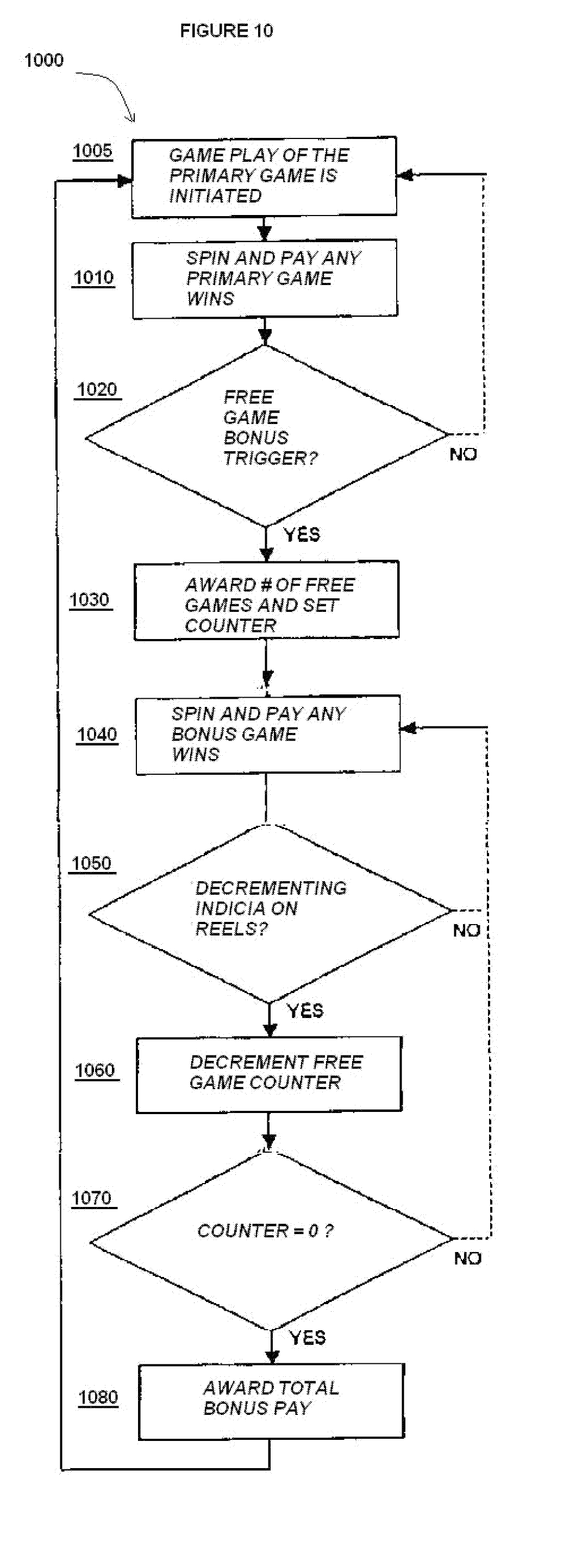

A logical flow diagram generally depicting the steps associated with a method 1000 for carrying out a selectable bonus game in accordance with one aspect of the invention is presented in FIG. 10. The order of actions as shown in FIG. 10 and described below is only illustrative, and should not be considered limiting. For example, the order of the actions may be changed, additional steps may be added or some steps may be removed without deviating from the spirit of the invention.

The base game is initiated at Block 1005. For example in a slot primary game, the player initiates play of the slot reels by inserting currency of some form, selecting the number of lines to play, the number of credits per line and presses a start switch or button. The reels are spun and the player may be awarded a base game award by the game or the game may trigger one or more free bonus games at Block 1010.

Regardless of win or loss in block 1010, it is determined whether any free game bonus trigger combinations appear on the reels at decision block 1020. If no triggering combination appears on the reels, processing returns to block 1005 and normal play continues, otherwise processing proceeds to block 1030.

A formula is applied to determine the number of free games to be awarded and the free game counter(s) are initialized, block 1030. A free bonus game is presented and any resulting wins are paid, either immediately or to a win meter, in block 1040.

At decision block 1050, it is determined if any decrementing symbols are present on the reels. If no decrementing symbols are present, processing returns to block 1040 and free game play continues, otherwise processing proceeds to block 1060, where one free game remaining icon is replaced by one free game expended icon for each decrementing symbol on the reels and the numeric indicator of the minimum number of remaining free games is adjusted.

The minimum number of free games remaining counter is examined at decision block 1070. If the minimum number of free games remaining is not zero, free game processing continues at block 1040, otherwise any credits on the bonus win meter are transferred to the game credit meter or otherwise paid at block 1080 and normal game play resumes at block 1005.

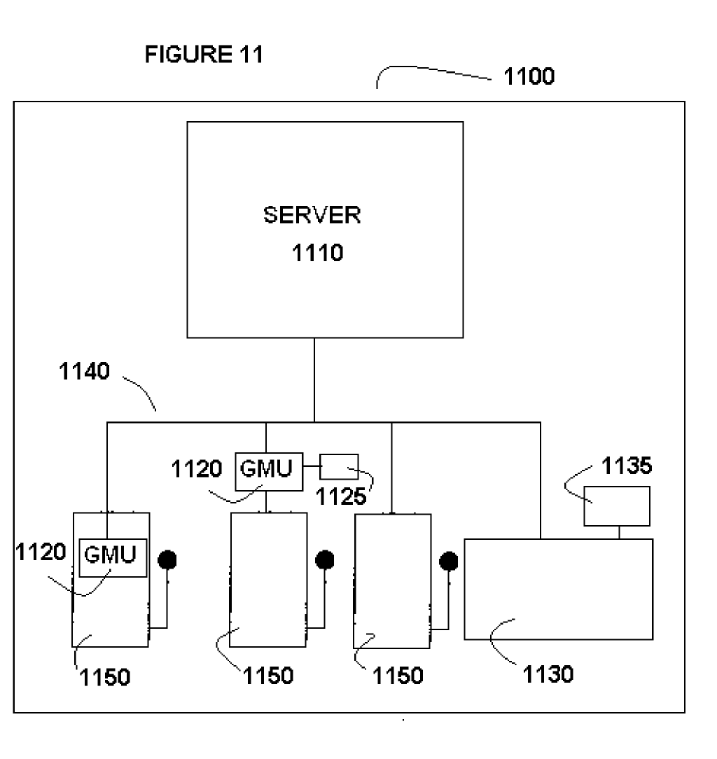

Referring to FIG. 11, in accordance with one aspect of the invention, gaming system 1100 includes server 1110, gaming machines 1150, and network 1140 connecting gaming machines 1150 to server 1110. Additionally, gaming display computer 1130 is shown connected to network 1140. Server 1110 may be selected from a variety of conventionally available servers. The type of server used is generally determined by the platform and software requirements of the gaming system. Examples of suitable servers are an IBM RS6000-based server, an IBM AS/400-based server or a Microsoft Windows-based server, but it should be appreciated that any suitable server may be used. It may also be appreciated that server 1110 may be configured as a single “logical” server that comprises multiple physical servers. Gaming machines 1150 operate similar to conventional peripheral networked terminals. Gaming machines 1150 have a player interface such as a display, a card reader, and selection buttons through which gaming machines 1150 interact with a player playing an open-ended bonus wagering game. The player interface is used for making choices such as the amount of a bet or the number of lines to bet. Gaming machines 1150 also provide information to server 1110 concerning activity on gaming machines 1150 and provide a communication portal for players with server 1110. For example, the player interface may be used for selecting different server-related menu options such as, but not limited to, transferring a specified number of credits from a player account onto the credit meter of the gaming machine, or for transferring credits from the gaming machine to a central player account.

In various embodiments, any of the gaming machines 1150 may be a mechanical reel spinning slot machine, video slot machine, video poker machine, keno machine, video blackjack machine, or a gaming machine offering one or more of the above described base games offering an open-ended bonus game. Networking components (not shown) facilitate communications across network 1140 between the system server 1110 and game management units 1120 and/or gaming display control computers 1130 that control displays for carousels of gaming machines. Game management units (GMU's) 1120 connect gaming machines to networking components and may be installed in the gaming machine cabinet or external to the gaming machine. The function of the GMU is similar to the function of a network interface card connected to a desktop personal computer (PC). Some GMU's have much greater capability and can perform such tasks as presenting and playing an open-ended bonus game using a display 1125 operatively connected to the GMU 1120. Displays related to open-ended bonus games being played on gaming machines 1150 or GMU displays 1125 may also be presented on gaming display 1135 by gaming display control computer 1130. In one embodiment, the GMU 1120 is a separate component located outside the gaming machine. Alternatively, in another embodiment, the GMU 1120 is located within the gaming machine. Optionally, in an alternative embodiment, one or more gaming machines 1150 connect directly to the network and are not connected to a GMU 1120. A gaming system of the type described above also allows a plurality of open-ended bonus games to be linked under the control of server 1110 for cooperative or competitive play in a particular area, carousel, casino or between casinos located in geographically separate areas.

One will appreciate that a gaming system may also comprise other types of components, and the above illustrations are meant only as examples and not as limitations to the types of components or games having an open-ended bonus game element in accordance with various embodiments of the invention in a gaming system. Additionally, it may further be appreciated that each of the games could be operated on a remote host computer such that a player initiates play with the host computer over a network via the player interface and gaming machine 850 operates the respective gaming and video displays in conjunction with the game whose play is controlled by the remote computer.

Although the description above contains much specificity, it should not be construed as limiting the scope of the invention but as merely providing an illustration of the presently preferred embodiment of the invention. The various embodiments disclosed herein are directed to a system and method for providing an open-ended bonus game in a gaming device. Embodiments of the system, method and gaming device are illustrated and described herein by way of example only and not by way of limitation. Those skilled in the art will readily recognize various modifications and changes may be made to the invention without departing from the true spirit and scope of the claimed invention as set forth below.

What is claimed is:

1. A game comprising:
an interface activatable by a player; at least one of a set of possible outcomes determined after activation of the interface by the player, the set of possible outcomes including a winning subset of outcomes; a bonus game initiated upon a triggering event; and a register that is modified by one or more units based on predefined criteria, the bonus game terminating when the register contains a predefined value.

2. The game of claim 1 wherein the triggering event is based on the determined outcome being a member of the winning subset of outcomes.

3. The game of claim 1 wherein the triggering event is not based on the determined outcome being a member of the winning subset of outcomes.

4. The game of claim 1 wherein the triggering event is based on the number of games played.

5. The game of claim 1 wherein the predetermined criteria are based on the appearance of certain indicia during play of the bonus game.

6. The game of claim 1 wherein the register increments based on the predefined criteria.

7. The game of claim 1 wherein the register decrements based on the predefined criteria.

8. The game of claim 1 wherein the predefined value is zero.

9. The game of claim 1 wherein the predefined value is not zero.

10. A method of operating a game, the method including the steps of:
selecting one of a set of possible outcomes of the game, the set of possible outcomes including a winning subset of outcomes;
upon a triggering event, initiating a bonus game;
modifying a register by one or more units based on predefined criteria, and terminating the bonus game when the register contains a predefined value.

11. The method of claim 10, wherein the triggering event is based on the selected outcome being a member of the winning subset of outcomes.

12. The method of claim 10, wherein the triggering event is not based on the selected outcome being a member of the winning subset of outcomes.

13. The method of claim 10, wherein the triggering event is based on the number of games played.

14. The method of claim 10, wherein the predetermined criteria are based on the appearance of predefined indicia during play of the bonus game.

15. The method of claim 10, wherein the register increments based on the predefined criteria.

16. The method of claim 10, wherein the register decrements based on the predefined criteria.

17. The method of claim 10, wherein the predefined value is zero.

18. The method of claim 10, wherein the predefined value is not zero.
